(19) United States
(12) Patent Application Publication
(10) Pub. No.: US 2025/0000102 A1
(43) Pub. Date: Jan. 2, 2025

(54) CEREAL FLOUR COMPOSITION AND DOUGH FOOD PRODUCT

(71) Applicants: Nisshin Seifun Group Inc., Tokyo (JP); NISSHIN FLOUR MILLING INC., Tokyo (JP); Nisshin Seifun Welna Inc., Tokyo (JP); NISSHIN SEIFUN PREMIX INC., Tokyo (JP); Oriental Yeast Co., Ltd., Tokyo (JP)

(72) Inventors: Masashi YOSHIDA, Fujimino-shi (JP); Noriyuki SHIBAMOTO, Fujimino-shi (JP); Kenji NAKAMURA, Fujimino-shi (JP); Nobuhito YOSHIMURA, Fujimino-shi (JP); Hajime TOYOTA, Tokyo (JP); Kei NOMURA, Fujimino-shi (JP); Keisuke OZAWA, Fujimino-shi (JP); Koichi ITO, Tokyo (JP); Chihiro AITA, Tokyo (JP)

(73) Assignees: Nisshin Seifun Group Inc., Tokyo (JP); NISSHIN FLOUR MILLING INC., Tokyo (JP); Nisshin Seifun Welna Inc., Tokyo (JP); NISSHIN SEIFUN PREMIX INC., Tokyo (JP); Oriental Yeast Co., Ltd., Tokyo (JP)

(21) Appl. No.: 18/703,870

(22) PCT Filed: Jan. 23, 2023
(86) PCT No.: PCT/JP2023/001966

§ 371 Date: Apr. 23, 2024

(30) Foreign Application Priority Data
Feb. 2, 2022 (JP) 2022-015209

(51) Int. Cl. A21D 8/04; A23L 7/104

(52) U.S. Cl. CPC A21D 8/04; A23L 7/104

(57) ABSTRACT

The present invention provides a cereal flour composition containing a cereal-derived powder, and an enzyme belonging to the tannase family, wherein the tannase activity per 1 g of the cereal-derived powder is from 0.1 to 60 kU/g. Preferably, the content of the enzyme in terms of mass is from 10 to 10000 ppm with respect to the total amount of the cereal-derived powder. Preferably, the cereal-derived powder includes at least one type selected from wholemeal flour, bran, and other cereal flour having an ash content of 0.7 mass % or greater. Preferably, the cereal-derived powder has an ash content of 0.5 mass % or greater.

### TECHNICAL FIELD

The present invention relates to a cereal flour composition and a dough food product.

### BACKGROUND ART

Techniques for treating cereal flour with various types of enzymes have conventionally been known. For example, Patent Literatures 1 and 2 disclose modifying an enzyme, such as xylanase, to bran in order to increase water holding capacity.

Patent Literature 3 discloses an enzyme preparation for releasing ferulic acid from a plant material, wherein the enzyme preparation contains an enzyme having a ferulic acid esterase activity, and at least one type of enzyme selected from arabinofuranosidase and xylanase.

As regards tannase, Patent Literature 4 discloses the use thereof in an oral composition.

### CITATION LIST

### Patent Literature

Patent Literature 1: US 2013045304A1
Patent Literature 2: US 201113640077A
Patent Literature 3: JP 2014-057529A
Patent Literature 4: JP 2011-162491A

### SUMMARY OF INVENTION

There has conventionally been a tendency for consumers to avoid noodles and bakery food products, such as breads and confectionery, which contain cereal-derived powders having a relatively high ash content, such as wholemeal flour, unpolished brown rice, bran (epidermis), etc., because such cereal-derived powders have acridness and odor attributed to bran. The recent health trend, however, has promoted the active use of cereal-derived powders, such as wholemeal flour, unpolished brown rice, bran, etc., which contain the epidermis and have a relatively high ash content. This, therefore, calls for a reduction in acridness and odor.

Further, noodles and bakery food products, such as breads and confectionery, may also call for a soft yet resilient/tough texture as well as extensibility and/or resilience of dough.

Patent Literatures 1 to 4, however, do not give any consideration to these issues.

The present invention aims to provide (1) or (2) below.
(1) A cereal flour composition in which acridness and odor attributed to cereal-derived powder(s) are reduced when used in dough food products, such as noodles, bakery food products, etc.
(2) A cereal flour composition capable of improving the soft yet resilient/tough texture and also improving extensibility and/or resilience of dough when used in dough food products, such as noodles, bakery food products, etc.

The present invention provides a cereal flour composition containing a cereal-derived powder, and an enzyme belonging to the tannase family, wherein a tannase activity per 1 g of the cereal-derived powder is from 0.1 to 60 kU/g.

It is preferable that the cereal flour composition contains, in terms of mass, from 10 to 10000 ppm of the enzyme with respect to a total amount of the cereal-derived powder.

It is preferable that the cereal-derived powder contains at least one type selected from wholemeal flour, bran, and cereal flour other than wholemeal flour and having an ash content of 0.7 mass % or greater.

It is preferable that the cereal-derived powder has an ash content of 0.5 mass % or greater.

The present invention also provides a dough food product containing the aforementioned cereal flour composition.

### DESCRIPTION OF EMBODIMENTS

The present invention will be described below according to preferred embodiments thereof.

The present invention provides a cereal flour composition containing a cereal-derived powder, and an enzyme belonging to the tannase family, wherein a tannase activity per 1 g of the cereal-derived powder is from 0.1 to 60 kU/g.

The cereal flour composition of the present invention contains an enzyme belonging to the tannase family. Examples of enzymes belonging to the tannase family encompass tannase and some ferulic acid esterases. The classification of the tannase family is based, for example, on the ESTER database (http://bioweb.supagro.inra.fr/ESTHER/general?what=index; searched on Feb. 2, 2022) which classifies esterases. In the present invention, from the viewpoint of imparting, to the cereal flour composition, a tannase activity of from 0.1 to 60 kU/g per 1 g of the cereal-derived powder, it is preferable to contain tannase as an enzyme belonging to the tannase family. In the present invention, an enzyme belonging to the tannase family may have other enzymatic activities in addition to tannase activity, such as a ferulic acid esterase etc.

Further, the cereal flour composition of the present invention contains an enzyme belonging to the tannase family, and has a tannase activity attributed to the possession of this enzyme. In the present Description, “tannase activity” refers to an activity of acting on and hydrolyzing molecules having depside bonds, such as tannic acid, gallic acid esters, digallic acid, gallotannin, ellagitannin, etc. The degree of activity of the enzyme is not particularly limited, so long as the cereal flour composition of the present invention has a tannase activity of “from 0.1 to 60 kU/g”.

One reason that the cereal flour composition of the present invention can modify/improve dough properties and texture by having the aforementioned tannase activity is thought to be because the enzyme belonging to the tannase family splices out polyphenols and ferulic acid, which is a type of polyphenol, and the reducing action of the polyphenols and ferulic acid, which is a type of polyphenol, enhances the hydrophobic interaction between proteins. Further, one reason that the cereal flour composition of the present invention can reduce acridness and odor by having the aforementioned tannase activity is thought to be because polyphenol polymers, which are substances responsible for acridness, can be reduced in molecular weight, thus making acridness less perceivable.

The cereal flour composition of the present invention has a tannase activity of 0.1 kU/g or greater per 1 g of the cereal-derived powder, and in this way, when used in dough food products such as bakery food products, noodles, etc., the cereal flour composition can reduce acridness and odor, such as bran odor, of cereal-derived powders having a relatively high ash content, such as wholemeal flour, bran, unpolished brown rice, etc. Further, this facilitates the achievement of resilient and/or extensible dough properties and texture with excellent softness and resilience/toughness in the aforementioned dough food products. Note that, in the present Description, “dough properties” refer to properties that can be evaluated as “feel of dough” perceived at the time of dough handling.

Further, the cereal flour composition of the present invention has a tannase activity of 60 kU/g or less per 1 g of the cereal-derived powder, and in this way, product cost can be suppressed while sufficiently achieving reduction of bran odor and acridness of cereal-derived powders having a relatively high ash content and also achieving effects of resilient and/or extensible dough properties and a texture with excellent softness and resilience/toughness in dough food products using the cereal flour composition. From this viewpoint, it is preferable that the tannase activity per 1 g of the cereal-derived powder in the cereal flour composition is preferably from 0.1 to 60 kU/g, more preferably from 0.3 to 13 kU/g, particularly preferably from 0.7 to 6.0 kU/g.

The tannase activity of the cereal flour composition is defined as a value measured according to the following method.

### {Tannase Activity Measurement Method}

A modified Deschamps method (J. Ferment. Technol., 61 [1], 55-59, 1983) is employed to measure the tannase activity of the cereal flour composition.
(1) 0.5 g of wheat flour mixed with an enzyme belonging to the tannase family is dispersed in 10 ml of a 50 mM citric acid buffer solution (pH 5.0) to conduct extraction at 125 rpm at 37° C. for 30 minutes. Then, the liquid is subjected to centrifugation at 4700 rpm for 10 minutes, to obtain the supernatant.
(2) 0.5 ml of the obtained supernatant is added to 0.5 mL of a 50 mM citric acid buffer solution (pH 5.0) containing 1 mass % of tannic acid (Tannic acid, ACS Reagent [SIGMA]), and is incubated at 37° C. for 30 minutes. Then, a 0.2 M acetic acid buffer solution (pH 5.0) containing 2 mass % of BSA is added thereto to terminate the reaction. Thereafter, the solution is left to stand in ice for 20 minutes, and then the solution is subjected to centrifugation at 3,000 rpm for 20 minutes, to collect the supernatant. The supernatant is diluted as appropriate, and the absorbance at a wavelength of 260 nm is measured.
(3) As a blank, the absorbance is measured for a solution obtained by subjecting 0.5 g of wheat flour that does not contain any enzyme belonging to the tannase family to the same processes as in (1) and (2) above.
(4) The absorbance of each sample is found by subtracting the absorbance value of the blank using the wheat flour of (3) from the absorbance of the sample in (2). A calibration curve is created using gallic acid, and the amount of enzyme for releasing 1 μmol of gallic acid in 1 minute is defined as 1 unit. This activity measurement is conducted in triplicate, and the average value is determined.

As for the wheat flour to be used in the tannase activity measurement, it is preferable to use “Million” (product name) from Nisshin Flour Milling Inc. If the cereal flour composition includes, per 1 g of the cereal-derived powder, an amount of enzyme belonging to the tannase family that offers a tannase activity of from 0.1 to 60 kU/g per 1 g of wheat flour when measured according to the aforementioned method, the cereal flour composition is deemed as having the aforementioned tannase activity. It should be noted that Inventors have also verified that, in cases of measuring, according to the same method as above, the difference in absorbance before and after actually adding an enzyme to the respective cereal-derived powder of each Example instead of using the aforementioned reference wheat flour, the actual measurement value based on the difference in absorbance exhibits the same value as the activity found in each Example, thus satisfying the activity value of from 0.1 to 60 kU/g.

It is preferable that the cereal flour composition of the present invention contains, in terms of mass, from 10 to 10000 ppm of the enzyme belonging to the tannase family with respect to the total amount of the cereal-derived powder. By containing at least 10 ppm of the enzyme belonging to the tannase family, the cereal flour composition can easily reduce bran odor and acridness of cereal-derived powders having a relatively high ash content, such as wholemeal flour, bran, unpolished brown rice, etc., more effectively in dough food products using the cereal flour composition. Further, by containing at least 10 ppm of the enzyme belonging to the tannase family with respect to the total amount of the cereal-derived powder, the cereal flour composition can effectively achieve a texture having excellent softness and resilience/toughness in dough food products using the cereal flour composition.

Further, by containing, in terms of mass, at most 10000 ppm of the enzyme belonging to the tannase family with respect to the total amount of the cereal-derived powder, the cereal flour composition of the present invention can more easily reduce acridness and bran odor and improve dough properties and texture. From this viewpoint, it is preferable that the cereal flour composition of the present invention contains, in terms of mass, from 10 to 10000 ppm of the enzyme belonging to the tannase family with respect to the total amount of the cereal-derived powder, and when taking into consideration the effects and the increase in cost of adding the enzyme, the content is more preferably from 50 to 2000 ppm, particularly preferably from 100 to 1000 ppm.

It should be noted that, preferably, the enzyme belonging to the tannase family to be used in the present invention is not a modified enzyme which has been modified to obtain such properties as to simultaneously hydrolyze nonpolar lipids, glycolipids and phospholipids. Examples of enzyme modification may include modification of enzymes by random mutagenesis (U.S. Pat. No. 4,814,331, WO93/01285, and WO95/22615), and modification of enzymes by site-directed mutagenesis (WO97/04079). Stated differently, “modification” refers to artificial insertion, loss, or substitution of an amino acid into a structural part of an amino acid chain of the enzyme.

The enzyme belonging to the tannase family to be used in the present invention may be derived from actinomycetes, filamentous fungi, and bacteria, and particularly, Aspergillus oryzae (koji mold) is preferable in terms of cost and easy availability.

As described above, the enzyme belonging to the tannase family may be derived from microbes, but products separated from microbes and refined are preferable in terms of purity. For example, in cases where the enzyme belonging to the tannase family is to be included in the cereal flour composition, it is preferable that the enzyme is not included as sake lees from the viewpoint of purity and content of contaminating enzymes.

Further, it is preferable that the cereal flour composition of the present invention is obtained by directly mixing the enzyme belonging to the tannase family with other materials from the viewpoint of uniform mixing and achieving enzymatic functions. Herein, “other materials” may include material flours, such as cereal flours etc., and water. For example, it is preferable that the cereal flour composition of the present invention does not contain a treated product obtained by a process involving: (a) a step of adding water to a particulate cereal bran fraction to obtain a water content of less than 100% (w/w); and (b) a step of treating the water-added particulate cereal bran fraction with an enzyme belonging to the tannase family. Herein, “particulate” means that the average particle size is smaller than 3000 μm. Herein, “average particle size” refers to volume cumulative particle diameter D50 at a cumulative volume of 50 vol %, as measured in a dry mode with a laser diffraction/scattering particle size distribution measurement device.

Further, it is preferable that the cereal flour composition of the present invention does not include the enzyme belonging to the tannase family as an enzyme-treated product of Amla. Furthermore, it is preferable that the cereal flour composition of the present invention does not include the enzyme belonging to the tannase family as an enzyme-treated product of tea or tea extract, or as an enzyme-treated product of vanilla beans or vanilla bean extract.

Further, it is preferable that the cereal flour composition of the present invention is not obtained through a step of mixing cereal flour with fresh tea leaves, or treated products thereof, in which enzymatic activities have not been lost. Among crushed fresh tea leaves obtained by crushing fresh tea leaves as-is or in the presence of water, a slurry preparation obtained by making the crushed fresh tea leaves into a slurry, and a tea leaf extract solution and tea leaf extract residue obtained by subjecting the same to solid liquid separation, “treated products of fresh tea leaves” may refer to at least one selected from the group consisting of (1) crushed fresh tea leaves, (2) slurry preparation, (3) tea leaf extract solution and tea leaf extract residue, (4) tea leaf extract residue, (5) tea leaf extract solution and tea leaf extract residue subjected to an enzyme inactivation treatment, (6) tea leaf extract solution, and (7) tea leaf extract residue and tea leaf extract solution subjected to enzyme inactivation treatment.

The cereal flour composition of the present invention contains a cereal-derived powder. Examples of the cereal-derived powder may include cereal flours, by-products during cereal flour production, and cereal flour-derived proteins.

Examples of cereal flours may include wheat flour, such as soft wheat flour (cake flour), medium-strength wheat flour (all-purpose flour), hard wheat flour (bread flour), durum wheat flour, etc., buckwheat flour, rice flour, corn flour, barley flour, rye flour, adlay flour, oat, Japanese barnyard millet flour, foxtail millet flour, soybean flour, and wholemeal flours of cereal grains described above.

Examples of by-products during cereal flour production may include bran etc.

Examples of cereal-derived proteins may include gluten etc.

The aforementioned “bran” refers to cereal bran, and refers to portions such as the pericarp, testa, germ, etc., produced when cereals are polished. In the present invention, it is possible to use, as bran, remainders obtained by removing the endosperm from cereal grains, or portions obtained by further removing the germ from such remainders, which are produced in the course of flour milling. Bran may be referred to as aleurone. Further, wheat bran may be referred to as bran.

The cereal-derived powder is preferably one type, or two or more types, selected from cereal flours, bran, and gluten, and more preferably contains cereal flour or bran, and particularly preferably contains cereal flour.

From the viewpoint of achieving effects caused by the enzyme belonging to the tannase family and obtaining a soft yet resilient/tough texture, it is preferable that the percentage of the total amount of cereal flour and bran in the cereal-derived powder is preferably 70 mass % or greater, more preferably 80 mass % or greater.

From the viewpoint of obtaining an acridness/odor inhibition effect from the enzyme belonging to the tannase family and obtaining resilient and/or extensible dough properties as well as a soft yet resilient/tough texture, it is preferable that, when using both cereal flour and bran in combination in the cereal-derived powder, the mass ratio between cereal flour and bran is preferably 100:10-50, more preferably 100:20-45, particularly preferably 100:25-40.

Particularly, from the viewpoint of achieving effects caused by the enzyme belonging to the tannase family and easily obtaining resilient and/or extensible dough properties as well as a soft yet resilient/tough texture, the percentage of the cereal flour in the cereal-derived powder is preferably 50 mass % or greater, more preferably 70 mass % or greater, particularly preferably 80 mass % or greater.

For example, from the viewpoint of achieving effects caused by the enzyme belonging to the tannase family and easily obtaining resilient and/or extensible dough properties as well as a soft yet resilient/tough texture, in cases where wheat flour or wheat wholemeal flour is included as the cereal-derived powder, the content of wheat flour or wheat wholemeal flour in the cereal-derived powder is preferably 50 mass % or greater, more preferably 70 mass % or greater, particularly preferably 80 mass % or greater.

Further, in cases where cereal flour of a cereal other than wheat is used as the cereal flour in the cereal-derived powder, the content of cereal flour of a cereal other than wheat in the cereal-derived powder may be 20 mass % or greater, or 50 mass % or greater, or 70 mass % or greater, or may particularly be 80 mass % or greater.

From the viewpoint of easily obtaining texture and properties characteristic to dough food products by forming a protein-based skeleton, it is preferable that the cereal-derived powder contains wheat flour or wheat wholemeal flour, or contains a cereal flour-derived protein such as gluten etc. Further, from the viewpoint of easily obtaining texture and properties characteristic to dough food products, in cases where the cereal-derived powder contains a cereal-derived protein, the percentage of the total amount of the cereal flour and the cereal-derived protein in the cereal-derived powder is preferably 5 mass % or greater, more preferably 10 mass % or greater.

Further, from the viewpoint of easily forming a skeleton and easily obtaining a desired texture, in cases where the cereal-derived powder contains a cereal-derived protein, it is preferable that, in the cereal-derived powder, the mass ratio between the cereal flour and the cereal flour-derived protein (ratio of the cereal flour to the cereal flour-derived protein) is preferably 100:2-40, more preferably 100:5-10.

Particularly, in cases where a cereal flour of a cereal other than wheat is to be used as the cereal flour, it is preferable that the mass ratio (ratio of the cereal flour of a cereal other than wheat to the cereal flour-derived protein) is preferably 100:2-40, more preferably 100:5-10.

Further, as shown in the Examples described further below, in the present invention, by using an enzyme belonging to the tannase family, it is possible to improve not only texture but also dough properties. From the viewpoint of easily improving the texture and properties of the obtained dough, in cases of using a cereal-derived powder, it is preferable that the crude protein amount thereof is from 5 to 15 mass %, more preferably from 7 to 13 mass %. An example of a method for measuring the crude protein amount is a method disclosed in JP 2012-254052A.

From the viewpoint of achieving the effect of reducing acridness and odor originating from the cereal-derived powder, it is preferable that the cereal flour composition contains at least one type selected from wholemeal flour, bran, and cereal flour other than wholemeal flour and having an ash content of 0.7 mass % or greater.

Herein, as for “wholemeal flour”, in the present invention, it is possible to use wholemeal flour of any of the various cereal grains described above; from the viewpoint of the quality of processed products, it is particularly preferable to use, for example, wheat wholemeal flour, unpolished brown rice flour, barley wholemeal flour, rye wholemeal flour, etc. Particularly, in the present invention, the use of wheat wholemeal flour is preferable in terms that the effect of ameliorating acridness can be easily achieved, because acridness is likely to be perceived in cases where the present invention is not employed.

The ash content of cereal wholemeal flour is typically 0.7 mass % or greater, preferably from 0.7 to 1.8 mass %, particularly preferably from 0.7 to 1.5 mass %.

Further, in the present invention, bran of wheat/barley-related species, such as wheat, barley, adlay, oat, rye, etc., rice, and other minor cereals can be used without particular limitation. Particularly, the use of wheat bran is preferable in terms that the effect of ameliorating acridness can be easily achieved, because acridness is likely to be perceived in cases where the present invention is not employed. Wheat bran may be referred to as bran or aleurone. The ash content of bran (cereal bran) is typically 0.7 mass % or greater, and may be 2.0 mass % or greater, and is preferably 7.0 mass % or less.

Examples of the cereal flour other than wholemeal flour and having an ash content of 0.7 mass % or greater may include the aforementioned various types of cereal flours, such as wheat flour, buckwheat flour, rice flour, corn flour, barley flour, rye flour, adlay flour, oat, Japanese barnyard millet flour, foxtail millet flour, soybean flour, etc., in which the ash content is 0.7 mass % or greater. Examples of wheat flour may include “Seikei” (Nisshin Flour Milling Inc.), “Duelio” (Nisshin Flour Milling Inc.), and wheat flours such as durum wheat semolina flour.

From the viewpoint of achieving the effect of reducing acridness and bran odor, it is preferable that the percentage of wholemeal flour, bran, and other cereal flour having an ash content of 0.7 mass % or greater is preferably 20 mass % or greater, more preferably 30 mass % or greater, even more preferably 50 mass % or greater, in the cereal flour composition.

From the viewpoint that an excellent effect of reducing acridness and bran odor can be achieved, it is preferable that, in the cereal flour composition, the cereal-derived powder itself has an ash content of 0.5 mass % or greater, more preferably 0.7 mass % or greater. The ash content of the cereal-derived powder is preferably 3.0 mass % or less, more preferably 2.0 mass % or less.

The cereal flour composition may or may not contain ingredients other than the cereal-derived powder and the enzyme belonging to the tannase family. In cases where the composition contains other ingredients, examples of such other ingredients may include starches, sugars, oils/fats, proteins originating from materials other than cereal flour, such as powdered milk, dried egg, etc., common salt, leavening agents, yeast, thickening agents, emulsifiers, egg shell calcium, enzymes, taste agents, spices, coloring agents, aroma flavorings, etc.

From the viewpoint of reducing acridness and odor attributed to bran and easily achieving resilient and/or extensible dough properties and a soft yet resilient/tough texture, it is preferable that the percentage of the cereal-derived powder in the cereal flour composition is 20 mass % or greater, more preferably 50 mass % or greater.

The cereal flour composition of the present invention can be used in doughs for various food products.

Examples of food product doughs may include doughs for bakery food products, doughs for noodles, and doughs/batters for crusts of deep-fried foods. Examples of dough food products using the food product dough may include bakery food products, noodles, etc.

Examples of doughs for bakery food products may include fermented or non-fermented doughs obtained by mixing the cereal flour composition, water/moisture, and, as necessary, auxiliary materials such as starches, yeast or leavening agents (baking powder etc.), common salt, table sugar, etc. “Bakery food product” refers to a food product obtained by subjecting the aforementioned bakery food product dough to a heating treatment such as baking, steaming, deep-frying, etc. Concrete examples of bakery food products and doughs therefor may include: breads; pizzas; cakes; Japanese-style and Western-style baked confectionery such as waffles, cream puffs, biscuits, dora-yaki (Japanese-style round pancakes having bean jam sandwiched in between), baked manju (Japanese-style buns with filling), etc.; steamed confectionery such as Chinese steamed buns, curry-stuffed steamed buns, etc.; deep-fried confectionery such as doughnuts etc.; snack foods such as okonomiyaki (Japanese-style griddlecake), jijimgae (Korean-style griddlecake), negi-yaki (Japanese-style green onion griddlecake), etc.; and doughs therefor. Examples of breads may include bread loaves, sweet buns, French bread, hard rolls, baguettes, pastries, etc. Examples of cakes may include bars, cookies, pancakes, hotcakes, etc.

Noodle doughs are obtained by mixing and kneading the cereal flour composition, water/moisture, and, as necessary, auxiliary materials such as salt, starches, etc. The dough may be rolled and then shaped, or may be extruded and formed into noodle shapes. Noodles can be obtained by subjecting the noodle dough to drying or to heating such as boiling, steaming, deep-frying, etc. Concrete examples of noodles and doughs therefor may include: soba (buckwheat noodles), udon (thick wheat noodles), hiyamugi (medium-thickness wheat noodles), Chinese noodles, spaghetti, macaroni, ravioli, noodle skin/wrappers such as spring roll wrappers, gyoza wrappers, etc.; and doughs therefor.

In the food product dough, examples of materials other than the enzyme belonging to the tannase family and the cereal-derived powder may include starches (starch and modified starch), sugars, oils/fats, proteins such as powdered milk, dried egg, etc., common salt, leavening agents, yeast, thickening agents, emulsifiers, egg shell calcium, enzymes, taste agents, spices, coloring agents, aroma flavorings, water, eggs, liquid milk, etc.

From the viewpoint of enhancing the effect of reducing acridness and/or bran odor and the effect of improving resilient and extensible dough properties and soft yet resilient/tough texture, it is preferable that, in the food product dough using the cereal flour composition of the present invention, the total of cereal-derived powder(s) originating from the cereal flour composition is preferably 20 mass % or greater, more preferably 40 mass % or greater, even more preferably 50 mass % or greater. The amount of cereal-derived powder(s) originating from the cereal flour composition is not limited as long as the content of other ingredients can be secured, and for example, the amount may preferably be 85 mass % or less, more preferably 75 mass % or less, in the food product dough.

An example of a process for preparing a food product dough using the cereal flour composition of the present invention may include a process of mixing the cereal flour composition as well as other raw materials, such as water/moisture, and other ingredients as necessary, and making the mixture into a dough.

The dough food product of the present invention is particularly preferably a bakery food product or a noodle food product. In this case, it is possible to suitably enhance the effect of reducing acridness and/or bran odor as well as the effect of improving resilient and/or extensible dough properties and soft yet resilient/tough texture. Particularly, from the viewpoint of easily achieving the effect of improving resilient and/or extensible dough properties and soft yet resilient/tough texture, it is preferable that the dough food products are breads, pizzas, confectioneries selected from steamed confectionery, hotcakes, doughnuts, dora-yaki, sponge cake, butter cake, pancakes and muffins, or noodles. Further, from the viewpoint of easily achieving the effect of reducing acridness and/or bran odor, the cereal flour composition of the present invention can be used, without particular limitation, in applications in which the cereal flour composition is used by being heated; from the viewpoint of significantly achieving the effect of improving texture and resilient and/or extensible dough properties, it is preferable that the composition is used in breads, pizzas, confectioneries selected from steamed confectionery, hotcakes, doughnuts, dora-yaki, sponge cake, butter cake, pancakes and muffins, or noodles.

Particularly, from the viewpoint of achieving the effect of enhancing the extensibility and resilience of dough, it is particularly preferable that the dough food product is bread. With the present invention, the extensibility of dough can be increased, and thus, the volume of bakery food products, such as bread, can be increased.

From the viewpoint of easily achieving the effect of improving soft yet resilient/tough texture and further improving resilient/tough dough properties, it is preferable that the food product dough containing the cereal flour composition has a moisture content of preferably from 15 to 70 mass %, more preferably from 15 to 50 mass %, even more preferably from 20 to 30 mass %. The moisture content of the dough can be measured according to the heating/drying method, wherein, for example, a sample is dried at 135° C. for 2 hours, or at 105° C. for 5 hours, and the moisture content is calculated from the change in weight before and after drying. Note that the aforementioned numerical range is deemed as being satisfied even in cases where the moisture content falls within the aforementioned numerical range when the sample is dried according to either one of the condition at 135° C. for 2 hours or the condition at 105° C. for 5 hours, but does not when dried according to the other condition.

### EXAMPLES

### Example 1

For the cereal-derived powder, wheat wholemeal flour (product name “Super Fine Hard” from Nisshin Flour Milling Inc.; ash content: 1.5 mass %) was used. For the enzyme belonging to the tannase family, tannase from Amano Enzyme Inc. (product name “Tannase-KTFHR”; Tannase No. 1) was used. With respect to the wheat wholemeal flour, 10 ppm of the tannase was mixed in terms of mass, to prepare a cereal flour composition. The tannase activity of the cereal flour composition measured according to the aforementioned method had the value shown in Table 1. Note that “Percentage (%)” as shown in Table 1 refers to the mass ratio in the total amount of the cereal-derived powder (same for Tables 2 to 5).

### Examples 2 to 8 and 10

Cereal flour compositions were prepared as in Example 1, except that the cereal-derived powder was changed to the products shown in Table 1, and the added amount of tannase with respect to the total amount of the cereal-derived powder was changed to the amounts shown in Table 1. The tannase activity of the respective cereal flour compositions measured according to the aforementioned method are also shown in Table 1.

Note that details of the cereal-derived powders used in Examples 5 to 8 and 10 are as follows.
Rye wholemeal flour: Product name “Alle Fine” from Fresh Food Service Co., Ltd.; ash content: 1.5 mass %
Wheat flour 1: Product name “Million” from Nisshin Flour Milling Inc.; ash content: 0.4 mass %
Wheat flour 2: Strong wheat was used as the material and was milled to a yield of 850‰ using a Laboratory Mill from Buhler, to prepare wheat flour having an ash content of 0.75 mass %. This was employed as Wheat flour 2.
Wheat bran: Product name “Wheat Bran M” from Fresh Food Service Co., Ltd.; ash content: 5.9 mass %
Wheat gluten: Product name “Super Glu 85H” from Nippon-Colloid; ash content: 1.2 mass %
Barley wholemeal flour: Product name “Ohmugi Ko (barley flour)” from Hakubaku Co., Ltd.; ash content: 1.7 mass %
Unpolished brown rice flour: Product name “Genmai Ko (unpolished brown rice flour)” from Mitake Food Manufacturing Co., Ltd.; ash content: 1.2 mass %

### Example 9

For the enzyme belonging to the tannase family, tannase from Mitsubishi-Chemical Foods Corporation (product name “Tannase”; Tannase No. 2 shown in Table 1) was used instead of Tannase No. 1, and was mixed with respect to wheat wholemeal flour according to the content shown in Table 1. Other than the above, a cereal flour composition was prepared as in Example 1.

### Comparative Examples 1 to 6

In Comparative Examples 1 to 6, no enzyme was mixed to the respective cereal-derived powders, and the respective cereal-derived powders shown in Table 1 were used as-is as cereal flour compositions of the Comparative Examples. Note that the cereal-derived powders in Table 1 are the same as those used in Examples 1, 5 to 8 and 10, respectively.

The cereal flour compositions according to Examples 1 to 10 and Comparative Examples 1 to 6 were used for evaluating bread making as described below.

### {Evaluation 1: Bread Loaf}

320 g, in terms of cereal-derived powder, of the cereal flour composition to be evaluated was placed in a mixing bowl of a commercially available bread-making mixer (Universal Mixer 5DM-03-r from Dalton Corporation), together with 8 g of common salt, 32 g of table sugar, 9.2 g of fresh yeast (“Oriental Yeast” from Oriental Yeast Co., Ltd.), and about 190 to 260 g of water in an amount achieving appropriate dough properties, and a mixing step was conducted, to prepare bread dough. More specifically, mixing was conducted at low speed for 4 minutes, and then mixing was conducted at high speed for 2 minutes. Further, 16 g of oil/fat was added and mixing was conducted at low speed for 4 minutes, and then, kneading was conducted at high speed for 1 minute (dough kneading temperature: 27° C.). The obtained bread dough was fermented under conditions of 27° C., 75% RH for 1 hour, and then, the dough was divided into 450 g pieces, and was left to stand for a bench time of 30 minutes. The bread dough was shaped into a rod-form and placed in a bread loaf pan. Then, the dough was left for final proof (temperature: 38° C.; relative humidity: 85% RH) for 60 minutes, and was then baked at a temperature of 200° C. for 30 minutes, to obtain a bread loaf.

The obtained bread loaf was left to cool at room temperature for 18 to 27 hours. Then, 10 expert panelists evaluated acridness, bran odor, and texture (softness and resilience) according to the following criteria. The average value of the evaluation scores is shown in Table 1.

### {Acridness}

1: Acridness is perceived very strongly.
2: Acridness is perceived.
3: Acridness is somewhat perceived.
4: Acridness is slightly perceived.
5: No acridness is perceived.

### {Bran Odor}

1: Bran odor is perceived very strongly.
2: Bran odor is perceived.
3: Bran odor is somewhat perceived.
4: Bran odor is slightly perceived.
5: No bran odor is perceived.

### {Texture (Softness and Resilience)}

1: Hard and no resilience.
2: Somewhat hard and somewhat lacking resilience.
3: Somewhat soft and somewhat resilient.
4: Soft and resilient.
5: Very soft and very resilient.

TABLE 1

| | Cereal flour product | | | | | | | | | | |
|---|---|---|---|---|---|---|---|---|---|---|---|
| | | | | | Ash content | | | | | | |
| | | | | | of cereal | Tannase | | | | | |
| | Cereal flour | | Bran/cereal protein | | flour | | | Added | Bread | | |
| | | Percentage | | Percentage | product | | Activity | amount | Acrid- | Bran | |
| | Type | (mass %) | Type | (mass %) | (mass %) | No. | (kU/g) | (ppm) | ness | odor | Texture |
| Example 1 | Wheat | 100 | — | 0 | 1.5 | No. 1 | 0.1 | 10 | 3.0 | 3.0 | 3.0 |
| Example 2 | wholemeal | | | | 1.5 | | 0.7 | 100 | 3.5 | 3.5 | 3.5 |
| Example 3 | flour | | | | 1.5 | | 6.0 | 1000 | 3.8 | 3.8 | 3.8 |
| Example 4 | | | | | 1.5 | | 60.0 | 10000 | 4.2 | 4.2 | 4.2 |
| Example 5 | Rye | 100 | — | 0 | 1.5 | | 6.0 | 1000 | 3.4 | 3.4 | 3.4 |
| | wholemeal | | | | | | | | | | |
| | flour | | | | | | | | | | |
| Example 6 | Wheat flour 1 | 80 | Wheat bran | 20 | 1.5 | | 6.0 | 1000 | 3.8 | 3.8 | 3.8 |
| Example 7 | Barley | 95 | Wheat gluten | 5 | 1.7 | | 6.0 | 1000 | 3.8 | 3.8 | 3.8 |
| | wholemeal | | | | | | | | | | |
| | flour | | | | | | | | | | |
| Example 8 | Unpolished | 95 | Wheat gluten | 5 | 1.2 | | 6.0 | 1000 | 4.0 | 4.0 | 4.0 |
| | brown rice | | | | | | | | | | |
| | flour | | | | | | | | | | |
| Example 9 | Wheat | 100 | — | 0 | 1.5 | No. 2 | 1.5 | 1000 | 3.3 | 3.3 | 3.3 |
| | wholemeal | | | | | | | | | | |
| | flour | | | | | | | | | | |
| Example 10 | Wheat flour 1 | 70 | Wheat flour 2 | 30 | 0.5 | No. 1 | 6.0 | 1000 | 3.8 | 3.8 | 3.8 |
| Comparative | Wheat | 100 | — | 0 | 1.5 | | 0 | 0 | 1.5 | 1.5 | 1.5 |
| Example 1 | wholemeal | | | | | | | | | | |
| | flour | | | | | | | | | | |
| Comparative | Rye | 100 | — | 0 | 1.5 | | 0 | 0 | 1.0 | 1.0 | 1.0 |
| Example 2 | wholemeal | | | | | | | | | | |
| | flour | | | | | | | | | | |
| Comparative | Wheat flour 1 | 80 | Wheat bran | 20 | 1.5 | | 0 | 0 | 1.8 | 1.8 | 1.8 |
| Example 3 | | | | | | | | | | | |
| Comparative | Barley | 95 | Wheat gluten | 5 | 1.7 | | 0 | 0 | 1.5 | 1.5 | 1.5 |
| Example 4 | wholemeal | | | | | | | | | | |
| | flour | | | | | | | | | | |
| Comparative | Unpolished | 95 | Wheat gluten | 5 | 1.2 | | 0 | 0 | 2.0 | 2.0 | 2.0 |
| Example 5 | brown rice | | | | | | | | | | |
| | flour | | | | | | | | | | |
| Comparative | Wheat flour 1 | 70 | Wheat flour 2 | 30 | 0.5 | | 0 | 0 | 2.5 | 2.5 | 2.5 |
| Example 6 | | | | | | | | | | | |

Comparisons of Examples 1 to 4 and 9 with Comparative Example 1, Example 5 with Comparative Example 2, Example 6 with Comparative Example 3, Example 7 with Comparative Example 4, Example 8 with Comparative Example 5, and Example 10 with Comparative Example 6 in Table 1 show that, by adding an enzyme belonging to the tannase family and obtaining an activity of from 0.1 to 60 kU/g, acridness and bran odor of cereal flour were reduced, and soft and resilient texture was improved.

### Examples 11 to 13

The cereal flour composition obtained in Example 3 was used as-is as the cereal flour compositions of Examples 11 to 13.

### Comparative Example 7

The cereal flour composition obtained in Comparative Example 1 was used as-is as the cereal flour composition of Comparative Example 7.

The cereal flour compositions according to Examples 11 to 13 and the cereal flour composition according to Comparative Example 7 were used for evaluating noodle making as described below.

### {Evaluation 2: Noodles}

To the cereal flour composition being tested, 1 part by mass of common salt and 40 parts by mass of water were added with respect to 100 parts by mass of the cereal-derived powder of the cereal flour composition, and this was mixed with a mixer (from Hobart) at low speed for 5 minutes. The obtained crumb-state noodle dough was gathered with a noodle-making roller and was compounded, rolled, and shaped into noodles, to obtain 3-mm-thick, 4-mm-wide noodle strings. The obtained noodle strings were aged at 25° C. for the respective time periods shown in Table 2. The obtained noodle strings were boiled for 11 minutes, and then cooled in cold water. For the obtained noodles, acridness and bran odor were evaluated according to the aforementioned evaluation criteria, and also, texture (softness and toughness) was evaluated according to the evaluation criteria below.

The results are shown in Table 2.

### {Texture (Softness and Toughness)}

1: Hard and brittle.
2: Somewhat hard and somewhat brittle.
3: Somewhat soft and somewhat tough.
4: Soft and tough.
5: Very soft and very tough.

TABLE 2

| | | | | | | Noodle | | | |
|---|---|---|---|---|---|---|---|---|---|
| | | | Tannase | | | ribbon | | | |
| | Cereal flour product | | | | Added | aging | Noodles | | |
| | | Percentage | | Activity | amount | time | Acrid- | Bran | |
| | Type | (mass %) | No. | (kU/g) | (ppm) | (hours) | ness | odor | Texture |
| Example 11 | Wheat | 100 | No. 1 | 6.0 | 1000 | 0.5 | 4.0 | 4.0 | 3.0 |
| Example 12 | wholemeal | | | | | 1.0 | 4.5 | 4.5 | 3.1 |
| Example 13 | flour | | | | | 2.0 | 4.9 | 4.9 | 3.4 |
| Comparative | Wheat | 100 | — | 0 | 0 | 0.5 | 1.5 | 1.5 | 1.5 |
| Example 7 | wholemeal | | | | | | | | |
| | flour | | | | | | | | |

Comparison of Example 11 with Comparative Example 7 in Table 2 shows that, by adding an enzyme belonging to the tannase family and obtaining an activity of from 0.1 to 60 kU/g, acridness and bran odor of cereal flour were suppressed, and softness and toughness were improved, even when making noodles.

### Example 14

The cereal flour composition obtained in Example 3 was used as-is as the cereal flour composition of Example 14.

### Comparative Example 8

The cereal flour composition obtained in Comparative Example 1 was used as-is as the cereal flour composition of Comparative Example 8.

The cereal flour composition of Example 14 and the cereal flour composition of Comparative Example 8 were used for evaluating confectionery making as described below.

### {Evaluation 3: Confectionery (Pancake)}

To the cereal flour composition being evaluated (in terms of 50 g of cereal flour (cereal-derived powder)), 12.5 g of refined sugar and 2.5 g of baking powder were mixed. Then, in a bowl, 5 g of salad oil, 15 g of whole egg liquid, 40 g of cow milk, and 30 g of water were added thereto as liquid materials, and the mixture was stirred by hand-mixing with a whisk at 120 rpm for 1 minute and then left to stand for 10 minutes. Then, the dough was cooked at 180° C. for 3 minutes on one side and 2 minutes on the flip side. The cooked product was left to cool at 27° C. for 30 minutes. The obtained pancake was employed for the following evaluation. For the obtained pancake, acridness and bran odor were evaluated according to the aforementioned evaluation criteria, and also, texture (softness and resilience) was evaluated according to the evaluation criteria below. The results are shown in Table 3.

### {Texture (Softness and Resilience)}

1: Hard and no resilience.
2: Somewhat hard and somewhat lacking resilience.
3: Somewhat soft and somewhat resilient.
4: Soft and resilient.
5: Very soft and very resilient.

TABLE 3

| | | | Tannase | | | | | |
|---|---|---|---|---|---|---|---|---|
| | Cereal flour product | | | | Added | Confectionery (pancake) | | |
| | | Percentage | | Activity | amount | Acrid- | Bran | |
| | Type | (mass %) | No. | (kU/g) | (ppm) | ness | odor | Texture |
| Example 14 | Wheat | 100 | 1 | 6.0 | 1000 | 3.8 | 3.8 | 3.5 |
| | wholemeal | | | | | | | |
| | flour | | | | | | | |
| Comparative | Wheat | 100 | — | 0 | 0 | 1.5 | 1.5 | 1.5 |
| Example 8 | wholemeal | | | | | | | |
| | flour | | | | | | | |

Comparison of Example 14 with Comparative Example 8 in Table 3 shows that, by using a cereal flour composition containing an enzyme belonging to the tannase family and having an activity of from 0.1 to 60 kU/g, acridness and bran odor of cereal flour were suppressed, and softness and resilience were improved, even in pancakes.

### {Evaluation 4: Bread Loaf}

The cereal flour compositions of Examples 1 to 4 and Comparative Example 1 were respectively used for the bread-making steps in the procedure described in {Evaluation 1: Bread Making} above, to obtain bread loaves. For the obtained bread loaves, the feel of dough during manufacture was evaluated according to the following criteria. Also, the volume (cc) of each bread loaf was measured 2 hours after manufacture. The results are shown in Table 4.

As for the feel of dough, extensibility and resilience were evaluated at the time of rounding and at the time of shaping according to the following criteria. The results are shown in Table 4.

### {Feel of Dough}

1: Lacking in extensibility and resilience.
2: Somewhat lacking in extensibility and resilience.
3: Extensible and resilient.
4: Somewhat rich in extensibility and resilience.
5: Rich in extensibility and resilience.

TABLE 4

Bread

| | Feel of dough | Volume (cc) |
|---|---|---|
| Example 1 | 3.0 | 1555 |
| Example 2 | 3.2 | 1608 |
| Example 3 | 3.4 | 1647 |
| Example 4 | 3.6 | 1711 |
| Comparative | 2.0 | 1501 |
| Example 1 | | |

Comparisons of Examples 1 to 4 with Comparative Example 1 in Table 4 clearly show that, by using a cereal flour composition containing an enzyme belonging to the tannase family and having an activity of from 0.1 to 60 kU/g, it is possible to improve the dough's resilience and extensibility and increase volume.

### Examples 15 to 18

To wheat flour (product name “Million” from Nisshin Flour Milling Inc.), Tannase No. 1 as used in Example 1 was added in amounts (in terms of mass) as shown in Table 5, and was mixed. The enzymatic activities of the obtained cereal flour compositions were measured according to the aforementioned method. The results are shown in Table 5.

### Comparative Example 9

In Comparative Example 9, no enzyme was added to wheat flour, and wheat flour (product name “Million” from Nisshin Flour Milling Inc.) was used as-is as the cereal flour composition.

The cereal flour compositions of Examples 15 to 18 and Comparative Example 9 were respectively used for the bread-making steps in the procedure described in {Evaluation 1: Bread Making} above, to obtain bread loaves. For the obtained bread loaves, texture was evaluated according to the criteria in Evaluation 1 above, and the feel of dough during manufacture was evaluated according to the criteria in Evaluation 4 above. Also, the volume (cc) of each bread loaf was measured 2 hours after manufacture. The results are shown in Table 5.

TABLE 5

| | | | Tannase | | | | |
|---|---|---|---|---|---|---|---|
| | Cereal flour product | | | | Added | Bread | |
| | | Percentage | | Activity | amount | Feel of | Volume |
| | Type | (mass %) | No. | (kU/g) | (ppm) | dough | (cc) |
| Example 15 | Wheat | 100 | 1 | 0.1 | 10 | 3.8 | 1752 |
| Example 16 | flour 1 | 100 | 1 | 0.7 | 100 | 4.0 | 1799 |
| Example 17 | | 100 | 1 | 6 | 1000 | 4.2 | 1852 |
| Example 18 | | 100 | 1 | 60 | 10000 | 4.3 | 1910 |
| Comparative | Wheat | 100 | — | 0 | 0 | 3.0 | 1699 |
| Example 9 | flour 1 | | | | | | |

Comparisons of Examples 15 to 18 with Comparative Example 9 in Table 5 clearly show that, by using a cereal flour composition containing an enzyme belonging to the tannase family and having an activity of from 0.1 to 60 kU/g, it is possible to improve the dough's resilience and extensibility and increase volume.

### Comparative Example 10 and Examples 19 and 20

Cereal flour compositions were prepared according to the respective compositional makeup shown in Table 6 below (unit of composition: parts by mass). The ingredients used in Table 6 were as follows: wheat flour: “Ocean” (from Nisshin Flour Milling Inc.; ash content: 0.52 mass %); buckwheat flour: “Kameju H” (from Nikkoku Seifun Co. Ltd.; ash content: 1.8 mass %); wheat bran: “SF Bran” (from Nisshin Flour Milling Inc.; ash content: 6.0 mass %); wheat gluten: “A-Glu G” (from Glico Nutrition Co., Ltd.; ash content: 0.7 mass %). To 100 parts by mass of the obtained cereal flour composition, 38 parts by mass of a 5 mass % salt solution was added, and the mixture was mixed with a mixer at low speed for 5 minutes, to obtain a crumb-state dough. The obtained dough was passed between rollers to produce a noodle ribbon, and then the dough was compounded and rolled. Then, the dough was cut with a #16 square cutter at a thickness of 1.28 mm. The obtained noodles were dried with a drying machine at approximately 35° C. for 10 hours, to obtain dried noodles.

Then, 50 g of the dried noodles were boiled in 1 L of boiling water for 7 minutes and thereafter cooled under running water for 1 minute, and after draining water therefrom, three panelists ate the obtained noodles and evaluated bran odor (smell of bran) according to the aforementioned evaluation criteria, and also, the sense of roughness perceived in the mouth at the time of consumption was evaluated according to the evaluation criteria below. Note that no noodle soup base/dipping sauce etc. was applied. The average value of the evaluation scores is shown in Table 6.

### {Roughness}

1: Roughness is perceived very strongly.
2: Roughness is perceived.
3: Not much roughness is perceived.
4: Almost no roughness is perceived.
5: No roughness is perceived.

TABLE 6

| | | | Compar- | | |
|---|---|---|---|---|---|
| | | | ative | | |
| | | | Exam- | Exam- | Exam- |
| | | | ple 10 | ple 19 | ple 20 |
| Cereal | Cereal | Wheat flour | 45.8 | 45.8 | 45.7 |
| flour | flour | Buckwheat flour | 31.3 | 31.3 | 31.3 |
| product | Bran/cereal | Wheat bran | 18.8 | 18.8 | 18.8 |
| | protein | Wheat gluten | 4.2 | 4.2 | 4.2 |

| Tannase | No. | — | 1 | 1 |
|---|---|---|---|---|
| | Activity | 0 | 3.0 | 6.0 |
| | (kU/g) | | | |
| | ppm | 0 | 500 | 1000 |
| Evaluation of noodles | Bran odor | 2.0 | 4.0 | 4.5 |
| | Roughness | 2.0 | 4.0 | 4.5 |

### Comparative Example 11 and Examples 21 to 23

Cereal flour compositions were prepared according to the respective compositional makeup shown in Table 7 below (unit of composition: parts by mass). The ingredients used in Table 7 were as follows: durum semolina: durum wheat semolina “Leone G” (from Nisshin Flour Milling Inc.; ash content: 0.72 mass %); wheat bran: same as ingredient used in Examples of Table 6; wheat gluten: “WEIPRO” (from Sunbright Co., Ltd.; ash content: 1.0 mass %). To 100 parts by mass of the obtained cereal flour composition, 27 parts by mass of water was added, and the mixture was mixed with a mixer for 8 minutes. Within 15 minutes, the dough was extruded with a pasta machine MAC30 from Italpast S.r.L. under vacuum into noodle strings. After extrusion, the noodles were rapidly frozen. After being thawed, the noodles were boiled to a yield of 225% with respect to the flour content and then cooled with water, and rapidly frozen thereafter.

The frozen noodles were heated and thawed in a microwave oven. Then, five panelists evaluated bran odor and acridness according to the aforementioned evaluation criteria, and also, texture (softness and resilience) was evaluated according to the evaluation criteria below. The results are shown in Table 7.

### {Texture (Softness and Resilience)}

1: Hard and no resilience.
2: Somewhat hard and somewhat lacking resilience.
3: Somewhat soft and somewhat resilient.
4: Soft and resilient.
5: Very soft and very resilient.

TABLE 7

| | | | Comparative | Example | Example | Example |
|---|---|---|---|---|---|---|
| | | | Example 11 | 21 | 22 | 23 |
| Cereal flour | Cereal flour | Durum semolina | 75 | 75 | 75 | 75 |
| product | Bran/cereal | Wheat bran | 20 | 20 | 20 | 20 |
| | protein | Wheat gluten | 5 | 5 | 5 | 5 |

| | | | | | |
|---|---|---|---|---|---|
| Tannase | No. | — | 1 | 1 | 1 |
| | Activity | 0 | 0.1 | 0.6 | 6.0 |
| | (kU/g) | | | | |
| | ppm | 0 | 10 | 100 | 1000 |
| Evaluation of noodles | Bran odor | 2.0 | 3.0 | 3.5 | 3.5 |
| | Acridness | 2.0 | 3.0 | 3.5 | 3.5 |
| | Texture | 1.5 | 2.5 | 3 | 3.5 |

### Comparative Example 12 and Examples 24 to 26

Cereal flour compositions were prepared by mixing wheat wholemeal flour, tannase (only in the Examples), granulated sugar, and baking powder according to the respective compositional makeup shown in Table 8 below (unit of composition: parts by mass), and then the other ingredients shown in Table 8 were added thereto. The mixture was stirred and mixed with a beater at low speed for 2 minutes and at high speed for 2 minutes. The dough kneading temperature was 25° C. The obtained dough was shaped with a doughnut manufacturing device, and was cut with a plunger cutter into a ring-shaped doughnut dough (weight of dough: 30 g per piece) having an inner diameter of 41 mm. The dough was deep-fried at 180° C. for 1 minute, flipped, then further deep-fried for 1 minute. For wheat wholemeal flour, “Super Fine Soft” (from Nisshin Flour Milling Inc.; ash content: 1.5 mass %) was used.

Acridness and bran odor of the obtained doughnut were evaluated according to the aforementioned evaluation criteria 24 hours after deep-frying. The results are shown in Table 8.

TABLE 8

| | | Compar- | | | |
|---|---|---|---|---|---|
| | | ative | | | |
| | | Exam- | Exam- | Exam- | Exam- |
| | | ple 12 | ple 24 | ple 25 | ple 26 |
| Wheat wholemeal flour | | 100 | 100 | 100 | 100 |
| Tannase | No. | — | 1 | 1 | 1 |
| | Activity | 0 | 0.1 | 0.6 | 6.0 |
| | (kU/g) | | | | |
| | ppm | 0 | 10 | 100 | 1000 |
| Granulated sugar | | 30 | 30 | 30 | 30 |
| Baking powder | | 5 | 5 | 5 | 5 |
| Whole egg | | 25 | 25 | 25 | 25 |
| Cow milk | | 25 | 25 | 25 | 25 |
| Water | | 20 | 20 | 20 | 20 |
| Shortening | | 5 | 5 | 5 | 5 |
| Evaluation | Bran odor | 2.0 | 3.1 | 3.9 | 4.1 |
| of doughnut | Acridness | 2.0 | 3.0 | 3.7 | 3.8 |

### Comparative Examples 13 and 14 and Examples 27 and 28

The materials for the sponge dough were mixed according to the respective compositional makeup shown in Table 9 below (unit of composition: parts by mass), and the mixture was mixed at low speed for 7 minutes, and at mid-low speed for 1 to 2 minutes (dough kneading temperature: 24° C.). The dough was fermented at 27° C., 75% RH for 4 hours, to obtain a sponge dough. Further, among the materials for the kneading dough, the cereal flour composition, which was a mixture of cereal-derived powder(s), enzyme (only in the Examples), common salt, refined sugar and skimmed milk powder, and also oil/fat were added to the sponge dough, and further, other ingredients were added, and the mixture was mixed and kneaded at low speed for 10 minutes, at mid-low speed for 5 minutes, and at mid-high speed for 1 to 2 minutes (dough kneading temperature: 27° C.). The obtained bread dough was fermented under conditions of 27° C., 75% RH for 20 hours. Then, the dough was divided into 250 g pieces, then shaped and placed in a pan, and thereafter, fermented at 38° C., 85% RH for 50 minutes, and then baked at 230° C. for 40 minutes.

For the obtained bread, five panelists evaluated acridness and bran odor according to the aforementioned evaluation criteria 24 hours after baking, and also the feel of dough during manufacture was evaluated according to the following criteria. The results are shown in Table 9.

Note that wheat wholemeal flour and gluten were the same as the ingredients used in the Examples of Table 1. For wheat bran, “Wheat Bran MP” (from Fresh Food Service Co., Ltd.; ash content: 5.9 mass %) was used.

For the wheat flour, Wheat flour 1 used in the Examples of Table 1 was used. For the dough enhancer, “C Ante S” (from Oriental Yeast Co., Ltd.) was used. For the yeast, regular yeast (from Oriental Yeast Co., Ltd.) was used, and for the emulsifier, “MM-100” (from Riken Vitamin Co., Ltd.) was used.

### {Feel of Dough}

1: Lacking in extensibility and resilience.
2: Somewhat lacking in extensibility and resilience.
3: Extensible and resilient.
4: Somewhat rich in extensibility and resilience.
5: Rich in extensibility and resilience.

TABLE 9

| | | Comparative Example 13 | | Example 27 | | Comparative Example 14 | | Example 28 | |
|---|---|---|---|---|---|---|---|---|---|
| | | Sponge | Kneading | Sponge | Kneading | Sponge | Kneading | Sponge | Kneading |
| | | dough | dough | dough | dough | dough | dough | dough | dough |
| Cereal flour | Wheat | 70 | 30 | 70 | 30 | | | 1 | |
| product | wholemeal | | | | | | | | |
| | flour | | | | | | | | |
| | Gluten | 5 | — | 5 | — | — | — | — | — |
| | Wheat flour | — | — | — | — | 70 | 10 | 70 | 10 |
| | Wheat bran | — | — | — | — | — | 20 | — | 20 |
| Tannase | Activity | — | — | — | 6 | — | — | — | 6 |
| No. 1 | amount | | | | | | | | |
| | (kU/g) | | | | | | | | |
| | Added | — | — | — | 1000 | — | — | — | 1000 |
| | amount | | | | | | | | |
| | (ppm) | | | | | | | | |

| | | | | | | | | |
|---|---|---|---|---|---|---|---|---|
| Dough enhancer | 0.2 | — | 0.2 | — | 0.2 | — | 0.2 | — |
| Emulsifier | 0.3 | — | 0.3 | — | 0.3 | — | 0.3 | — |
| Yeast | 2 | — | 2 | — | 2 | — | 2 | — |
| Common salt | — | 2 | — | 2 | — | 2 | — | 2 |
| Refined sugar | — | 6 | — | 6 | — | 6 | — | 6 |
| Skimmed milk powder | — | 2 | — | 2 | — | 2 | — | 2 |
| Oil/fat (margarine) | — | 6 | — | 6 | — | 6 | — | 6 |
| Water | 55 | 28 | 55 | 28 | 55 | 28 | 55 | 28 |

| | | | | | |
|---|---|---|---|---|---|
| Evaluation of | Acridness | 1.8 | 4.2 | 1.7 | 4.4 |
| bread | Bran odor | 1.8 | 4.2 | 1.7 | 4.4 |
| | Feel of dough | 2.1 | 4.2 | 1.9 | 4.3 |

### Comparative Example 15 and Example 29

Cereal flour compositions were prepared by mixing the cereal-derived powders and Tannase No. 1 (only in the Example) among the compositional makeup shown in Table 10 below (unit of composition: parts by mass). Next, the other ingredients were added, and the mixture was mixed at low speed for 7 minutes, at mid-low speed for 7 minutes, and at mid-high speed for 1 to 3 minutes. The dough kneading temperature was 24° C. The dough was fermented for 10 minutes, then divided into 200 g pieces, and left to stand at 4° C. for a bench time of 8 to 12 hours. Then, the dough was stretched into a 28-cm-dia. circular shape. The dough was topped with food items, and was then baked at 450° C. for 1 minute 30 seconds. For the pizza, acridness and bran odor 1 hour after being baked, as well as the feel of dough, were evaluated according to the same evaluation criteria as in the examples of Table 9 above. The results are shown in Table 10. Note that, in Table 10 below, for the special-purpose wheat flour for French bread, “Lys d'or” (from Nisshin Flour Milling Inc.; ash content: 0.45 mass %) was used, and the other materials were the same as those for the Examples of Table 9.

TABLE 10

| | | Comparative | |
|---|---|---|---|
| | | Example 15 | Example 29 |
| Cereal flour | Special-purpose | 50 | 50 |
| product | wheat flour for | | |
| | French bread | | |
| | Wheat flour | 30 | 30 |
| | Wheat bran | 20 | 20 |
| | Gluten | 7 | 7 |
| Tannase | Activity value | — | 1000 |
| No. 1 | (kU/g) | | |
| | Added amount | 0 | 6 |
| | (ppm) | | |
| Yeast | | 1.3 | 1.3 |
| Common salt | | 2.3 | 2.3 |
| Oil/fat (shortening) | | 5 | 5 |
| Water | | 75 | 75 |
| Evaluation | Acridness | 2.0 | 4.5 |
| of pizza | Bran odor | 1.9 | 4.5 |
| | Feel of dough | 2.5 | 4.7 |

### Comparative Example 16 and Example 30

The materials for the sponge dough shown in Table 11 below (unit of composition: parts by mass) were mixed, and the mixture was mixed at low speed for 5 minutes, and at mid-low speed for 2 minutes (dough kneading temperature: 24° C.). The dough was fermented at 27° C., 75% RH for 60 minutes, to obtain a sponge dough. Further, among the materials for the kneading dough, a mixture of cereal-derived powders and enzyme (only in the Example) was added as a cereal flour composition to the sponge dough, and further, the other ingredients were added, and the mixture was mixed and kneaded at low speed for 10 minutes, at mid-low speed for 10 minutes, and at mid-high speed for 1 to 3 minutes (dough kneading temperature: 25° C.). The obtained bun dough was divided into 65 g pieces, shaped, then filled with a filling, and thereafter, fermented at 50° C., 40% RH for 40 minutes, and then steamed at 100° C.

The obtained meat-filled steamed bun was evaluated according to the same criteria as in Table 9 above. The results are shown in Table 11. Note that “Wheat flour (Camellia)” is a product (product name “Camellia”) from Nisshin Flour Milling Inc. having an ash content of 0.37 mass %. “Wheat flour (Flour)” is a product (product name “Flour”) from Nisshin Flour Milling Inc. having an ash content of 0.44 mass %. Wheat bran was the same as that used in the Examples of Table 1. For the dough enhancer, “C Ante S” (from Oriental Yeast Co., Ltd.) was used. The yeast and the emulsifier were the same as those used in the Examples of Table 9.

TABLE 11

| | | Comparative Example 16 | | Example 30 | |
|---|---|---|---|---|---|
| | | Sponge | Kneading | Sponge | Kneading |
| | | dough | dough | dough | dough |
| Wheat flour (Camellia) | | 50 | — | 50 | — |
| Wheat flour (Flour) | | — | 30 | — | 30 |
| Wheat bran | | — | 20 | — | 20 |
| Tannase | Activity | — | — | — | 6 |
| No. 1 | value | | | | |
| | (kU/g) | | | | |
| | Added | — | — | — | 1000 |
| | amount | | | | |
| | (ppm) | | | | |

| | | | | |
|---|---|---|---|---|
| Yeast food | 0.05 | — | 0.05 | — |
| Baking powder | — | 1 | — | 1 |
| Emulsifier | 0.3 | — | 0.3 | — |
| Yeast | 1 | 2 | 1 | 2 |
| Common salt | — | 0.3 | — | 0.3 |
| Glucose | 2 | — | 2 | — |
| Refined sugar | — | 13 | — | 13 |
| Corn syrup | — | 5 | — | 5 |
| Skimmed milk powder | — | 1 | — | 1 |
| Oil/fat (shortening) | — | 6 | — | 6 |
| Water | 27.5 | 9.5 | 27.5 | 9.5 |

| | | | |
|---|---|---|---|
| Evaluation | Acridness | 1.3 | 3.7 |
| of meat- | Bran odor | 1.2 | 3.9 |
| stuffed | Feel of | 1.7 | 3.7 |
| steamed bun | dough | | |

### Comparative Example 17 and Example 31

To 100 parts by mass of wheat wholemeal flour (product name “Super Fine Hard” from Nisshin Flour Milling Inc.), 140 parts by mass of water, 1 part by mass of common salt, and an amount of enzyme belonging to the tannase family (only in the Example) as described in the experimental plot were added, and the mixture was mixed and kneaded, to obtain a fluid-state dough. Using a drum-type baking machine, the fluid-state dough was baked on the drum surface, to manufacture spring roll wrappers having a thickness of from 0.5 to 0.55 mm.

Note that, in both Comparative Example 17 and Example 31, at the time of baking the fluid-state dough in the noodle skin/wrapper production step, there was no problem in workability, although the dough exhibited slight brittleness or stickiness.

Using the spring roll wrappers obtained in Comparative Example 17 and Example 31, spring rolls were manufactured. More specifically, the spring roll wrapper was cut into a 190×190 mm square. Then, food items cooked in advance were placed on the cut spring roll wrappers, and then each wrapper was folded, to obtain spring rolls for deep-frying. The spring rolls for deep-frying were completely frozen at −40° C., and thereafter freeze-stored at −20° C. Then, the frozen spring rolls were deep-fried in salad oil at 170 to 180° C., and immediately after deep-frying, the spring rolls were subjected to a texture sensory test. In the texture sensory test, ten panelists ate the spring rolls and evaluated acridness and bran odor according to the aforementioned evaluation criteria. The evaluation results (average score of ten panelists) are shown in Table 12 below.

TABLE 12

| | | Comparative | |
|---|---|---|---|
| | | Example 12 | Example 31 |
| Wheat wholemeal flour | | 100 | 100 |
| Water | | 140 | 140 |
| Common salt | | 1 | 1 |
| Tannase | No. | — | 1 |
| | Activity | 0 | 6.0 |
| | value | | |
| | (kU/g) | | |
| | Added | — | 1000 |
| | amount | | |
| | (ppm) | | |
| Evaluation | Acridness | 1.5 | 3.5 |
| of spring | Bran odor | 1.5 | 3.0 |

### Comparative Example 18 and Example 32

To 100 parts by mass of wheat wholemeal flour (product name “Super Fine Hard” from Nisshin Flour Milling Inc.), 1 part by mass of common salt, 35 parts by mass of water (water temperature: 10 to 15° C.), and an amount of enzyme belonging to the tannase family (only in the Example) as described in the experimental plot were added, and the mixture was mixed. Using a vertical mixer, the mixture was mixed and kneaded at room temperature at low speed for 10 minutes, to prepare dough for gyoza wrappers.

The dough obtained as above was rolled, to manufacture gyoza wrappers, each having a thickness of approximately 0.9 mm and a diameter of approximately 90 mm.

Approximately 15 g of gyoza filling per gyoza wrapper was placed on each manufactured gyoza wrapper, and the filling was wrapped in the wrapper according to an ordinary method, to manufacture raw gyoza dumplings.

The gyoza dumplings were placed in a frying pan coated with oil, and then 20 g of water per gyoza was poured in, and in this state, the gyoza dumplings were steam-cooked with the lid on. The gyoza dumplings were grilled for about 7 to 8 minutes, then the lid was removed to let the water evaporate. Oil was poured lightly around the gyoza dumplings, and the dumplings were grilled until well browned.

For the gyoza dumplings 30 minutes after being grilled, ten expert panelists evaluated acridness and bran odor according to the aforementioned criteria. The average value of the evaluation scores is shown in Table 13.

TABLE 13

| | | Comparative | |
|---|---|---|---|
| | | Example 18 | Example 32 |
| Wheat wholemeal flour | | 100 | 100 |
| Water | | 35 | 35 |
| Common salt | | 1 | 1 |
| Tannase | No. | 0 | 1 |
| | Activity | 0 | 6 |
| | value | | |
| | (kU/g) | | |
| | Added | 0 | 1000 |
| | amount | | |
| | (ppm) | | |
| Evaluation of | Acridness | 1.5 | 3.5 |
| gyoza | Bran odor | 1.5 | 3 |

### Comparative Example 19 and Examples 33 to 35

Cereal flour compositions were prepared by mixing premix flour and tannase (only in the Examples) among the materials shown in Table 14 (unit of composition: parts by mass). Next, other ingredients except oil/fat were added and mixed at low speed for 3 minutes, at medium speed for 9 minutes, and at high speed for 4 minutes. Then, oil/fat was added and further mixed at medium speed for 5 minutes, and at high speed for 5 minutes (dough kneading temperature: 27° C.). After dividing the dough into 50 g pieces, the dough was left to stand for a bench time at room temperature for 20 minutes, then shaped into rolls, and thereafter, fermented at 35° C., 85% RH for 65 minutes. Next, the dough was baked at 210° C. for 8 minutes. The obtained bread was evaluated according to the following evaluation criteria. The results are shown in Table 14. For soybean flour-containing premix flour, “4LCB-2” (from Nisshin Seifun Premix Inc.; ash content: 2.8 mass %) was used. The ash content of soybean flour was 5.2 mass %.

### {Dough Properties}

1: Very strong resilience and does not stretch.
2: Resilient and does not stretch.
3: Resilient but stretches somewhat.
4: Somewhat resilient but stretches.
5: No resilience and good stretchability.

### {Acridness}

1: Very strong acridness.
2: Strong acridness.
3: Somewhat strong acridness.
4: Little acridness.
5: No acridness.

TABLE 14

| | | Compar- | | | |
|---|---|---|---|---|---|
| | | ative | | | |
| | | Exam- | Exam- | Exam- | Exam- |
| | | ple 19 | ple 33 | ple 34 | ple 35 |
| Premix flour | | 100 | 100 | 100 | 100 |
| Tannase | No. | — | 1 | 1 | 1 |
| | Activity | 0 | 0.6 | 3.0 | 6.0 |
| | value | | | | |
| | (kU/g) | | | | |
| | Added | — | 100 | 500 | 1000 |
| | amount | | | | |
| | (ppm) | | | | |
| Fresh yeast | | 3 | 3 | 3 | 3 |
| Water | | 88 | 88 | 88 | 88 |
| Whole egg | | 10 | 10 | 10 | 10 |
| Common salt | | 1.5 | 1.5 | 1.5 | 1.5 |
| Oil/fat (shortening) | | 18 | 18 | 18 | 18 |
| Evaluation | Dough | 1 | 2 | 3 | 4 |
| of bread | properties | | | | |
| | Acridness | 1 | 2 | 3 | 4 |

### INDUSTRIAL APPLICABILITY

The present invention can provide a cereal flour composition capable of reducing acridness attributed to cereal-derived powders and odor attributed to testa when used in dough food products such as noodles or bakery food products.

Further, the present invention can provide a cereal flour composition capable of improving extensibility and/or resilience of dough and offering a soft yet resilient/tough texture when used in dough food products such as noodles or bakery food products.

1. A cereal flour composition comprising:
a cereal-derived powder; and
an enzyme belonging to the tannase family,
wherein a tannase activity per 1 g of the cereal-derived powder is from 0.1 to 60 kU/g.

2. The cereal flour composition according to claim 1, wherein a content of the enzyme in terms of mass is from 10 to 10000 ppm with respect to a total amount of the cereal-derived powder.

3. The cereal flour composition according to claim 1, wherein the cereal-derived powder comprises at least one type selected from wholemeal flour, bran, and cereal flour other than wholemeal flour and having an ash content of 0.7 mass % or greater.

4. The cereal flour composition according to claim 1, wherein the cereal-derived powder has an ash content of 0.5 mass % or greater.

5. A dough food product comprising the cereal flour composition according to claim 1.
